(19) United States
(12) Patent Application Publication
(10) Pub. No.: US 2002/0147296 A1
(43) Pub. Date: Oct. 10, 2002

(54) Biodegradable composite material for the production of micro-capsules

(75) Inventors: Marianne Teller, Mistorf (DE); Hans-Werner Heinrich, Riemserort (DE); Joachim Teller, Mistorf (DE); Udo Meyer, Hastorf (DE)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: Bioserv AG, Rostock (DE)

(21) Appl. No.: 09/932,761

(22) Filed: Aug. 17, 2001

Related U.S. Application Data
(63) Continuation-in-part of application No. PCT/DE00/00526, filed on Feb. 20, 2000.

(30) Foreign Application Priority Data
Feb. 19, 1999 (DE) 199 07 227.2

(51) Int. Cl. C08G 69/00

(52) U.S. Cl. 528/271

(57) ABSTRACT

The invention relates to biodegradable polymeric composite material for the production of micro-capsules containing any kind of substances, e.g. foodstuffs, medicine and immunogens or technical materials such as oils, colorants, enzymes or similar.

According to the invention they have a polymeric composition of the general formula

R¹ₙ—P^{1—}(Q—P²)ᵢ—R²ₘ,

in which

P¹ and P² represent the same or different macromolecular structures,

R¹ and R² represent the same or different end groups or protective groups or receptor molecules or markers,

i, n and m are natural numbers and can be individually zero or one,

Q represents an at least bi-functional structure with hydrophilic properties, derived from the area of polyols, polyamides and polyester,

with the composition for splitting the bonds between the sub-structures R, P and/or inside Q having a enzymatic recognition site and/or interface.

This application is a continuation-in-part of PCT/DE00/00526 filed Feb. 20, 2000.

The invention relates to biodegradable polymeric composite material for the production of micro-capsules containing any kind of substances, e.g. foodstuffs, medicine and immunogens or technical materials such as oils, colorants, enzymes or similar.

The encasing of liquid or solid substances as a protection against external influences and in the form of small particles or capsules plays an important role for various fields of application, for example in the foodstuffs industry, pharmacy and technology. The physical, chemical and biological properties of the micro-particles are determined by

the production technology (spray-drying, coacervation, extrusion, encapsulation (emulsion and dispersion methods), co-polymerisation, micronisation by supercritical gases)

the matrix, covering/encapsulating materials (mono, di and polysaccharides, proteins, polyamino acids, polycarbonic acids, poly(lactid-co-glycolid), acrylates, poly-alcohols and their co-polymers, liposomes, silicates and similar in various combinations and mixture ratios) and

possible surface modification (immunglobulins, lectins, poly(ethylene glycol), ganglioside GM1, pharmacologically effective compounds)

Whereas the technologies for the production of small capsules or particles are state of the art, new capsule materials are being sought after for the permanently increasing fields of application.

Solutions are in particular being sought for the purposeful release of medicines protecting the encapsulated active agent safely against external influences, active as a transport vehicle into the area of effectivity planned and only releasing the active agent at the destination.

From U.S. Pat. No. 5,700,486, biodegradable polymers and co-polymers in pharmaceutical compositions for the formation of particles used for the controlled release of pharmacologically effective substances are known. The compositions stated are all physical mixtures of the standardised polymers and co-polymers, the pro rata compositions of which are varied before the encapsulation process. The disardvantage of such biodegradable polymers is that the release of the material is neither purposeful nor is it done by defined enzymatic effects.

U.S. Pat. No. 5,686,113 describes the micro-encapsulation in watery solutions. The biodegradable capsule material used is a mixture of an anionic polymer or its salts and an amino-functionalised monomer, with the formation of the reaction product taking place during the micro-encapsulation. Such mixtures have the disadvantage that the formation reaction of micro-capsules cannot be done simultaneously in watery and also in non-watery systems. The surface modifications described can be used to bind the particles selectively to certain ligands, but a specific dissolution of the wall of the capsule at the place of binding is not possible.

The task of the invention entails finding biodegradable capsules which permit a technically standardised method of production of micro-capsules with any kind of substances suited to temporary separation of any kind of materials, e.g. oils, colorants, enzymes, medicines, immunogens, nucleic acids etc. from the milieu surrounding them, and/or for a purposeful transport and controllable release of pharmaceutical active agents.

Surprisingly, a suitable capsule wall material is a polymeric composite material representing a standardised reaction product and having co-valent bindings between the sub-structures, with at least one of the components used possessing hydrophilic properties. This composite material permits the formation of micro-capsules of solid or dissolved materials or preparations both in watery and also in non-watery systems.

The biodegradable polymers according to the invention only bind to defined ligands and are also only split into sub-units under the influence of known factors. The new kind of polymers can be used for various applications.

Capsule materials are produced which bind specifically to target cells according to the purpose of the application, can be absorbed by them or can dissolve on the cell surface or in the interior of the cell. This basic concept of chemical compounding of non-degradable or difficult to degrade substances with materials specifically fissured by certain enzymes (composite materials) can be used for various biological and technical fields of application. Thanks to

use of these new materials

variations in the particle size (nm-μm)

multi-layered design of the wall making use of various composite materials and

use of various methods of micro-particle production thanks to “core-shell encapsulation” or co-polymerisation new transport systems for medicines are created. Purposeful surface modifications and selection of interfaces only fissured by defined body-inherent enzymes or such from disease pathogens made it possible to achieve particularly high concentrations of active agents at places with pathological reaction patterns.

Preferably, composite materials with the general formula

R¹ₙ—P¹—(Q—P²)ᵢ—R²ₘ

are used, wherein

P¹ and P² represent the same or different macromolecular structures, preferably from the areas of polyester, polyamide or polysaccharide,

R¹ and R² represent the same or different end groups or protective groups or receptor molecules or markers,

i, n and m are natural numbers and can be individually zero or one,

Q represents an at least bi-functional structure with hydrophilic properties, derived from the area of polyols, polyamides and polyester,

the capsule wall materials having an enzymatic recognition site and/or interface for splitting the bonds between the sub-structures R, P and/or inside Q.

Polymers with structure elements of hydroxycarbonic acids, their salts or esters are used particularly preferably for P¹ and P². Preferably, it is polyester, such as polyglycolides, polylactides, poly(hydroxybutyric acids) or co-polymers resulting therefrom, such as polygalacturonic acid or alginic acid. The end or protective groups R¹ and/or R² are acyl, alkyl or alkoxycarbonyl groups. In a different embodiment, R¹ and/or R² represent marker, receptor or molecules otherwise specifically binding on structures, preferably from the material classes of the oligopeptides, proteins, glycoproteins and oligonucleotides. Receptor molecules are preferably lectins, receptor ligands or antibodies.

As structure element Q, compounds are preferably suited which are derived from mono, oligo or polysaccharides and which, if need be, have amino or carboxy groups, or compounds which are derived from di, oligo or polypeptides. Preferably, structure element Q possesses enzyme recognition sites and interfaces, preferably it has a di or polysaccharide or an oligopeptide with a defined protease interface.

Mixtures of composite materials in which i=zero or i=1 are particularly preferably used as encapsulation material.

According to the invention, micro-capsules of materials e.g. pollutants such as mineral oil are produced with the composite material according to the invention for temporary separation from the surrounding milieu.

The use of the composite materials according to the invention with various marker and/or receptor molecules R¹ and/or R² has the advantage that they recognise extra and/or intra-cellular structures. With the use of the composite materials and the binding of a marker via the molecular recognition, a purposeful transport and a targeted release of the active agent with an immunological and/or pharmacological/toxic effect can be done at the place of effect.

The production of micro-capsules with any kind of substances, e.g. solid or dissolved materials from the areas of foodstuffs, pharmaceutical preparations or technical products or also aggregates making use of the composite materials according to the invention is done in organic solvents or watery solvents or watery emulsions with methods known per se, e.g. by core-shell methods.

| Abbreviations: | |
|---|---|
| Ac-PLA 17000 | O-Acetyl-polylactide 17000 |
| Ac-PLA 2000 | O-Acetyl-polylactide 2000 |
| BSA | Bovine serum albumin |
| ClAc-PLA 2000 | O-Chloracetyl-polylactide 2000 |
| DBU | 1,8-Diazabicyclo[5.4.0]undec-7-ene |
| DCC | N,N′-Dicyclohexylcarbodiimide |
| DMAP | 4-Dimethylaminopyridine |
| EDC | 1-Ethyl-3-(3- |
| | dimethylaminopropyl) carbodiimide |
| | hydrochloride |
| FMPT | 2-fluoro-1-methyl-pyridine-p-toluene |
| sulfonate | |
| Lektin | Lectin UEA I (Ulex Europaeus) |
| MS-PLA 2000 | O-Maleoyl-polylactide 2000 |
| MES buffer | 2-Morpholinoethansulfonic acid |
| MSA | Maleic acid anhydride |
| PGAS | Polygalacturonic acid 25000-50000 |
| PLA 17000 | Polylactide 17000 |
| PLA 2000 | Polylactide 2000 |
| PGlu | Polyglutamic acid 2000-15000 |
| BSA-RR2 | BSA reactive red 2 |

### EXAMPLE 1

Composite material of O-acetyl-polylactide 2000 and dilysine

Solutions of EDC (95.6 mg in 1 ml water) and DMAP (122 mg in 2 ml acetonitrile) are added to a solution of Ac-PLA 2000 (1 g) in acetonitrile (40 ml) in one portion. The reaction mixture is activated at rt for 30 min in an ultrasonic bath. A solution of H-Lys-Lys-OH.2 HCl (80.3 mg in 2 ml water) is added to the activated mixture and the entire mixture agitated at 50° C. for 2 h. After this, the reaction mixture is reduced to about 10 ml in a vacuum. The remaining oil is firstly washed with 30 ml ethanol/water (v/v:50/50). The solid matter formed is centrifuged (5000 RPM, 5 min), washed with 20 ml of water, centrifuged again and dried in a vacuum.

IR spectrum: 3342, 3335 (NH), 1759 (Ester), 1647 (Amide) ¹H-NMR: δ=1.44-1.61 (m, CH₃), 2.58-3.27 (m, CH₂), 5.08-5.15 (m, CH), 6.58-6.61 (m, NH), 8.15-8.17 (m, NH); ¹³C-NMR: δ=14.6, 15.5, 16.5, 17.6, 20.4, 20.5 (CH₃, PLA), 25.6, 34.9, 35.5, 36.7 (CH₂), 39.5, 40.9, 43.1 (CH), 55.6 (CH₂), 68.9 (CH, PLA), 106.5, 143.6 (CH), 169.5, 169.6, 169.8, 170.3 (CO, PLA), 175.0 (COOH, PLA), 175.8 (COOH)

### Production of the Polylactide Components

O-acetyl-polylactide 2000 of Polylactide 2000 )¹ with acetic acid anhydride )¹ Polylactide 2000 stands for the resomer L104/Poly(L-lactide) of the firm of Boehringer Ingelheim Pharma KG

10 g Polylactide 2000 is dissolved in acetone (150 ml) at room temperature. 2.36 ml acetic acid anhydride and 2.43 ml pyridine are each added in one portion. After this, there is heating for 5 h at 70° C. with reflux. After cooling, 2 ml of ice vinegar is added and the solution reduced on a rotation evaporator (bath temperature 40° C.). To remove the pyridine acetate, the crystalline residue is washed twice with 100 ml ethanol/water (v/v:50/50). The suspension is centrifuged (5000 RPM, 5 min) and the solid matter then dried on a rotation evaporator.

Yield: 9.4 g (94%)

### EXAMPLE 2

Composite material of O-acetyl-polylactide 2000 and dihistidine

Solutions of EDC (95.6 mg in 1 ml water) and DMAP (122 mg in 2 ml acetonitrile) are added to a solution of Ac-PLA 2000 (1 g) in acetonitrile (40 ml) in one portion. The reaction mixture is activated at rt for 30 min in an ultrasonic bath. A solution of H-His-His-OH•trifluoracetic acid (101.6 mg in 2 ml water) is added to the activated mixture and the entire mixture agitated at 50° C. for 2 h. After this, the reaction mixture is reduced to about 10 ml in a vacuum. The remaining oil is firstly washed with 30 ml ethanol/water (v/v:50/50). The solid matter formed is centrifuged (5000 RPM, 5 min), washed with 20 ml of water, centrifuged again and dried in a vacuum.

IR spectrum: 3504, 3496 (NH), 1759 (Ester), 1648 (Amide)

### EXAMPLE 3

Composite material of O-chloracetyl-polylactide 17000 and a peptide rich in cystein

A solution of H-Lys-Cys-Thr-Cys-Cys-Ala-OH•trifluoracetic acid (25 mg in 1 ml water) and DBU (20 μl) is added to a solution of ClAc-PLA17000 (1.73 g in 50 ml acetonitrile) and everything agitated for 3 h at 50° C. After this, the reaction mixture is reduced to about 10 ml in a vacuum. The remaining oil is washed with 40 ml ethanol/water (v/v:50/50) and the solution carefully poured off. This procedure is repeated with 30 ml ethanol and the product dried in a vacuum.

Elementary analysis: ber.: N, 0.19; gef.: N, 0.25 IR spectrum: 3504 (NH), 1751 (Ester), 1648 (Amide)

### Production of the polylactide components

Polylactide(diisopropylamide) 17000 of Polylactide 17000 with Diisopropylamine

0.7 ml diisopropylamine and 0.81 g CDI are each added to a solution of Polylactide 17000 )² (17 g) in dry acetone (100 ml) in one portion at 50° C. After this, there is agitation for 18-20 h at 50° C. )² Polylactide 17000 stands for the resomer R202H/Poly(D,L-lactide) of the firm of Boehringer Ingelheim Pharma KG

After cooling, the solution is neutralised with 1M acetic acid. Rotation is done until drying. The solid matter is then kept in a refrigerator for 1 h. After this, the dry product is transferred to a mortar and crushed. The crushed mass is added to 20 ml water, thoroughly stirred and sucked out via a Buchner funnel.

The product is frozen and lyophilised for drying.

(Chloracetyl)polylactide(diisopropylamide) 17000 (Cl-Ac-PLA17-IPA) of Polylactide-(diisopropylamide) 17000 with chlorinated acetic acid anhydride

4.275 g (0.25 mmol) Polylactide(diisopropylamide) 17000 is dissolved in 35 ml dry acetone. A solution of 214 mg (1.25 mmol) chlorinated acetic acid anhydride in 15 ml dry acetone is added to this solution. Following addition of 191 μl (1.375 mmol) Triethylamine, the reaction mixture is stirred for 5 h at 80° C. with reflux. After cooling, the solvent is removed in a vacuum. The solid matter obtained is thoroughly washed with distilled water, filtered and lyophilised.

Yield: 4.15 g (96.6%)

### EXAMPLE 4

Composite material of polygalacturonic acid and dilysine

BrCN solution (35 μl, c=0.1 g/l in acetonitrile) is diluted in 10 ml water and dripped into a solution of polygalacturonic acid (1.25 g) in Na₂CO₃ buffer (100 ml). After 15 min of agitation, a solution of H-Lys-Lys-OH.2 HCl (5.335 mg) in water (5 ml) is added and the reaction mixture agitated overnight at room temperature. The product is precipitated with ethanol, centrifuged (4000 RPM, 5 min) and freeze-dried.

IR spectrum: 3600-3100 (OH, NH), 1606 (bs sh, COOH, COO⁻, Amide), 1098 (C—O—C)

### EXAMPLE 5

Composite material of polygalacturonic acid and dihistidine

BrCN solution (35 μl, c=0.1 g/l in acetonitrile) is diluted in 10 ml water and dripped into a solution of polygalacturonic acid (1.25 g) in Na₂CO₃ buffer (100 ml). After 15 min of agitation, a solution of H-His-His-OH•trifluoracetic acid (6.24 mg) in water (5 ml) is added and the reaction mixture agitated overnight at room temperature. The product is precipitated with ethanol, centrifuged (4000 RPM, 5 min) and freeze-dried.

IR spectrum: 3600-3100 (OH, NH), 1608 (bs sh, COOH, COO⁻, Amide), 1098 (C—O—C)

### EXAMPLE 6

Composite material of polyglutamic acid and dihistidine

Polyglutamic acid (100 mg) is suspended in acetonitrile (10 ml). Solutions of EDC (2.24 mg in 1 ml water) and DMAP (2.144 mg in 1 ml acetonitrile) are added in one portion. The mixture is activated in an ultrasonic bath at 30° C. for 30 min. A solution of H-His-His-OH•trifluoracetic acid (2.4 mg) in water (1 ml) is added, followed by agitation for 2 h at 50° C. After this, the solid matter is centrifuged off (4000 RPM, 5 min), washed with 5 ml ethanol/water (v/v:50/50) and again centrifuged. This procedure is repeated with 5 ml water. The product is then freeze-dried.

IR spectrum: 3342, 3287(NH), 1733 (CO), 1645 (Amide)

### EXAMPLE 7

Composite material of O-acetyl-polylactide 2000 and lactose

Solutions of EDC (960 mg in 5 ml water) and DMAP (610 mg in 10 ml acetonitrile) are added to a solution of Ac-PLA 2000 (10 g) in acetonitrile (150 ml) in one portion. The reaction mixture is activated in an ultrasonic bath at room temperature for 30 minutes. A solution of lactose (1.8 g in 25 ml water) is added to the activated mixture and agitated for 2 h at 50° C. After this, the reaction mixture is reduced to about 20 ml in a vacuum. The residue is washed with 100 ml water, centrifuged (3500 RPM, 10 min) and dried in a vacuum.

¹H-NMR: δ=1.13-1.35 (m, CH₃), 1.45-1.62 (m, CH₃, PLA), 2.10 (s, CH₃), 2.57-2.71 (m, CH), 3.17 (s, CH), 4.30-4.37 (m, CH), 5.10-5.19 (CH, PLA); ¹³C-NMR: δ=14.6, 16.6, 16.7, 17.4, 20.5 (CH₃), 39.8, 42.77, 42.81, 43.0 (CH), 66.6, 68.2, 68.5, 68.7, 68.8, 68.9, 69.1, 69.4, (CH), 169.16, 169.2, 169.3, 169.6, 169.7, 170.3, 170.4 (C═O), 175.2 (COOH)

### EXAMPLE 8

Composite material of O-acetyl-polylactide 17000 and lactose

Solutions of EDC (96 mg in 1 ml water) and DMAP (61 mg in 1 ml acetonitrile) are added to a solution of Ac-PLA 17000 (8.5 g) in acetonitrile (100 ml) in one portion. The reaction mixture is activated in an ultrasonic bath at room temperature for 30 minutes. A solution of lactose (90 mg in 5 ml water) is added to the activated mixture and agitated for 2 h at 50° C. After this, the reaction mixture is reduced to about 20 ml in a vacuum. The residue is washed with 100 ml ethanol/water (v/v:50/50) and the solution carefully poured off. This procedure is repeated with 100 ml ethanol/water (v/v:50/50) and 50 ml ethanol. After this, the product is dried in a vacuum.

¹H-NMR: δ=1.18-1.26 (m, CH₃), 1.41-1.56 (m, CH₃, PLA), 1.98 (s, CH₃), 2.70 (s, CH), 3.12 (s, CH) , 3.68 (dd, CH), 4.13-4.21 (m, CH), 4.29-4.37 (m, CH), 5.06-5.23 (CH, PLA); ¹³C-NMR: δ=14.0, 16.6, 16.7, 18.4, 20.5 (CH₃), 58.3, 61.5 (CH₂), 66.57, 66.63, 68.9, 69.1, 69.2, 69.4 (CH), 169.1, 169.2, 169.3, 169.4, 169.5 (C═O)

MALDI-TOF-MS: confirms the AcO-PLA-Lactose-PLA-OAc structure

### Production of the Polylactide Component

O-acetyl-polylactide 17000 of Polylactide 17000 and acetic acid anhydride

17 g Polylactide 17000 is dissolved in acetone (150 ml) at room temperature. 472 μl acetic acid anhydride and 486 μl pyridine are each added in one portion. After this, there is heating for 5 h at 70° C. with reflux. After cooling, 0.5 ml ice vinegar is added and the solution reduced on a rotation evaporator (bath temperature 40° C.). To remove the pyridine acetate, the crystalline residue is washed twice with 100 ml ethanol/water (v/v:50/50). The suspension is centrifuged (5000 RPM, 5 min) and the solid matter then dried on a rotation evaporator.

Yield: 15 g (88%)

### EXAMPLE 9

Composite of O-(8-amino-3,6-dioxa-octylaminocarbonyl)polylactide (diisopropylamide) 17000 and 1-phenyl-β-D-lactopyranoside

ClCOONB (60.3 mg) dissolved in acetone (5 ml) as well as pyridine (80 μl) are added to a solution of 1-phenyl-β-D-lactopyranoside (52.3 mg) in absolute acetone (50 ml). The formation of the 1-phenyl-6,6′-bis-O-[norbornen-2,3-dicarboxamidoxy-carbonyl]-β-D-lactopyranoside is followed by thin-layer chromatography. The mixture is agitated for 5 h at room temperature, after which the solution is reduced to 5 ml. The O-(8-amino-3,6-dioxa-octylaminocarbonyl)polylactide(diisopropylamide) 17000 (4.32 g) is dissolved in absolute acetone (40 ml) and brought to pH 9-10 with pyridine and heated to 50° C. The disaccharide component is added drop by drop. For the completion of the reaction, the mixture is left to rest overnight at RT. The solution is reduced on a rotation evaporator, washed neutrally with 0.01 M acetic acid and then lyophilised.

Yield: 92%

The final product is characterised by means of GPC or by means of ¹H-NMR spectra.

### Production of the Polylactide Components

see Example 14

### Production of the Disaccharide Components

Octa-O-acetyl-β-D-lactopyranoside )^{3,4} of lactose with acetic anhydride )³ J. S. Matthews, Biochim. Biophys. Acta, 69 (1963), 163. )⁴ T. W. Greene, P. G. M. Wuts, Protective Groups in Organic Synthesis, 2. Aufl., Wiley: New York (1990).

250 ml of acetic anhydride is heated to boiling point in a three-necked flask (145° C.) . The flask is briefly removed from the oil bath and 50 g water-free sodium acetate added; the mixture is boiled again. Now, (highly exothermic!) dried and finely powdered lactose (30 g, 87.6 mmol) is added very cautiously and heated for 3 hours with reflux. After the reaction mixture has cooled, the solution is poured onto crushed ice and stirred for about 1 h. After addition of 150 ml chloroform, the phases are separated and the watery phase extracted twice with 75 ml chloroform each time. The united organic phases are washed twice with water (100 ml each time) and then dried over Na₂SO₄. The solvent is removed on a rotation evaporator under reduced pressure, traces of acetic anhydride and acetic acid removed azeotropically with toluene, thus resulting in a brown syrup-like product. By re-crystallisation in ether (or ethyl acetate), the product is obtained in the firm of colourless crystals.

(lactoside: DC eluent: toluene/ethyl acetate=2/1, R_{F}=0.21 maltoside: DC eluent: toluene/ethyl acetate=2/1, R_{F}=0.48)

| | Lactoside | Maltoside |
|---|---|---|
| Yield: | 74.7%; colourless | 60.0%; colourless |
| Melting point: | crystals | crystals |
| | 96-99° C.; (ethyl | — |
| | acetate)^{[i]} | |

Sum formula (Mol mass): C₂₈H₃₈O₁₉ (678.59 g/mol) NMR data for the lactoside: ¹³C-NMR (63 MHz, CDCl₃): δ=20.4, 20.5, 20.6, 20.7 (8×C(O)CH₃), 60.8, 61.7 (C-6 gal, C-6 glc), 66.6, 69.0, 70.5, 70.7, 70.9, 72.6, 73.5, 75.6 (C-2-C-5 gal, C-2-C-5 glc), 91.5 (C-1 glc), 100.8 (C-1 gal), 168.7, 168.9, 169.4, 169.5, 170.0, 170.2, 170.2 (8×C(O)CH₃).

1-phenyl-hepta-O-acetyl-β-D-lactopyranoside of octa-O-acetyl-β-D-lacto-pyranoside with phenol

20 g (29.47 mmol) Octa-O-acetyl-μ-D-lactopyranoside are dissolved in 100 ml absolute 1,2-dichloromethane. Cooled by ice, the solution is stirred for 15 minutes before 2.09 g (14.74 mmol) of the BF₃-etherate complex is slowly added by the drop. After further stirring for 15 minutes with ice cooling, 4.16 g (44.21 mmol) phenol are added. There is further stirring with ice cooling for 4 hours and then slow heating to room temperature. After a further 20 hours of stirring, the mixture is processed. For this, it is slowly treated with ice cooling and a saturated HCO₃ solution (100 ml) and stirred until no development of gas worth mentioning occurs. The phases are not separated and washed twice with water (50 ml each time), dried over Na₂SO₄ and reduced on a rotation evaporator. The following cleansing is done by column chromatography (CC).

(lactoside: DC, SC eluent: toluene/ethyl acetate=3/1, R_{F}=0.52 maltoside: DC eluent: toluene/ethyl acetate=1/1, R_{F}=0.61 SC eluent: toluene/ethyl acetate=3/1)

| | Lactoside | Maltoside |
|---|---|---|
| Yield: | 56.3%; Colourless | 68.4%; Colourless |
| Melting point.: | crystals | crystals |
| | 158-161° C. (Ethanol) | — |

Sum formula (Mol mass): C₃₂H₄₀O₁₈ (712.65 g/mol) NMR data for the lactoside: ¹³C-NMR (63 MHz, CDCl₃): δ=20.4, 20.5, 20.6 20.6, 20.6, 20.7, 20.7 (7×C(O)CH₃), 60.7, 61.9 (C-6 glc, C-6 gal), 66.5, 68.9, 70.6, 70.9, 71.4, 72.6, 72.7, 76.2 (C-2-C-5 glc, C-2-C-5 gal), 98.6, 100.9 (C-1 glc, C-1 gal), 116.8, 123.2, 129.5, 156.7 (C-Phenyl), 169.0, 169.5, 169.7, 170.0, 170.1, 170.2, 170.3 (7×C(O)CH₃).

1-phenyl-β-D-lactopyranoside from 1-phenyl-hepta-O-acetyl-β-D-lactopyranoside with CsF/Al₂O₃

11.75 g (16.49 mmol) 1-phenyl-hepta-O-acetyl-β-D-lactopyranoside is added to 100 ml absolute MeOH. After this, 1.2 g CsF/Al₂O₃ (1.53 mmol/g) is added. A very slight yellowing is observed in this. After a reaction time of at least 16 hours (DC control) there is filtration via kieselguhr. After reduction at reduced pressure on a rotation evaporator, there is re-crystallisation or the product is further processed. The de-acetylated compound is obtained in almost a quantitative yield.

| | Lactoside | Maltoside |
|---|---|---|
| Yield: | 97.6%; colourless | 98.0%; colourless |
| Melting point: | crystals | crystals |
| | 190.5-191.5° C. | — |
| | (methanol) | |

Sum formula (mol mass): C₁₈H₂₆O₁₁ (418.39 g/mol) NMR data for the lactoside: ¹³C-NMR (63 MHz, DMSO-D₆): δ=60.4, 60.6 (C-6 glc, C-6 gal), 67.9, 68.3, 70.7, 71.5, 72.8, 73.5, 75.1, 75.6 (C-2-C-5 glc, C-2-C-5 gal), 97.5, 100.0 (C-1 glc, C-1 gal), 116.6, 122.7, 129.8, 156.8 (C-Phenyl). NMR data for the maltoside: ¹³C-NMR (63 MHz, DMSO-D₆): δ=60.4, 61.0 (C-6 glc, C-6 gal), 70.0, 72.6, 73.0, 73.4, 73.7, 75.3, 76.4, 79.2 (C-2-C-5 glc, C-2-C-5 gal), 100.2, 100.9 (C-1 glc, C-1 gal), 116.3, 122.0, 129.6, 157.5 (C-Phenyl)

### EXAMPLE 10

Composite from composite of O-acetyl-polylactide 2000 and 1-phenyl-2,3,3′,4′,5′-penta-O-acetyl-6,6′-bis-O-[(ε)-amino-caproyl]-β-D-maltopyranoside

To start with, 0.29 g (0.14 mmol) Ac-PLA 2000 is dissolved in 10 ml dry dichloromethane. 0.116 g (0.718 mmol) 1,1′-carbonyl-diimidazol is added to the solution and the mixture stirred for 30 min at RT.

63.4 mg (0.072 mmol) 1-phenyl-2,3,3′,4′,5′-penta-O-acetyl-6,6′-di-O-[(ε) -amino-caproyl]-β-D-maltopyranoside is dissolved in 10 ml dry dichloromethane. This solution is added to the mixture at RT by stirring and heated to 50° C. After 4 h (DC control) the mixture is reduced on a rotation evaporator. The solid matter received is washed twice with 5 ml ethanol. For this, the suspension is held in an ultrasonic bath for about 5 min. The washed product is dried in a vacuum.

(DC eluent: toluene/ethyl acetate=1/2, R_{F}=0.10) Yield: 66.0% (amorphous solid matter) Mol mass≈2900 g/mol NMR data: ¹³C-NMR (63 MHz, CDCl₃) δ=16.3-16.8 (CH₃ (PLA)), 20.5 (5×C(O)CH₃) , 61.5 (C-6 gal, C-6 glc) , 68.3-69.4 (CH (PLA) , C-2-C-5 glc, C-2-C-5 gal), 169.1-170.3 (C(O) (PLA), 5×C(O)CH₃).

### Production of the Disaccharide Components

Most of the provisions are described for the lactose derivative. All the provisions also apply for the corresponding lactose and also maltose derivatives. If there are deviations in the synthesis of these two derivatives, they are stated in the conversions.

1-phenyl-6,6′-di-O-trityl-β-D-lactopyranoside of 1-phenyl-β-D-lactopyranoside with trityl chloride

The tritylation is done according to a provision analogous to the corresponding maltose derivative)⁵. For it, 6.735 g (16.09 mmol) 1-phenyl-β-D-lactopyranoside is dissolved in 100 ml dry pyridine and 10.78 g (38.67 mmol) trityl chloride added. In addition, 100 mg dimethylaminopyridine (DMAP) is added as a catalyst. The mixture is stirred for 90 hours at room temperature (DC control). After the end of the reaction, the mixture is poured onto ice water (400 ml), and the precipitated solid matter filtered off and then chromatographed. The ditritylated compound is obtained in a moderate yield. )⁵ K. Takeo, S. Kato, T. Kuge, Carbohydr. Res., 38 (1974), 346-351.

(lactoside: DC, SC eluent: chloroform/methanol=10/1, R_{F}=0.43 maltoside: DC eluent: chloroform/methanol=5/1, R_{F}=0.59, SC eluent: chloroform/methanol=10/1)

| | Lactoside | Maltoside |
|---|---|---|
| Yield: | 42.8%; yellow-brown | 37.0%; yellow-brown |
| | syrup | solid matter |

Sum formula (mol mass): C₅₆H₅₄₁₁ (903.02 g/mol) NMR data for the lactoside: ¹³C-NMR (63 MHz, CDCl₃): δ=61.9, 62.5 (C-6 glc, C-6 gal), 68.4, 71.3, 73.2, 73.4, 73.7, 74.2, 74.9, 78.9 (C-2-C-5 glc, C-2-C-5 gal), 100.4, 102.7 (C-1 glc, C-1 gal), 117.2, 122.7, 129.4, 157.1 (C-Phenyl), 143.4, 143.7 (2×C(Ph)₃).

1-phenyl-6,6′-di-O-trityl-2,3,3′,4′,5′-penta-O-acetyl-β-D-lactopyranoside aus 1-phenyl-6,6′-di-O-trityl-β-D-lactopyranoside with acetic anhydride

The 1-phenyl-6,6′-di-O-trityl-β-D-lactopyranoside (6.30 g, 6.98 mmol) is added to a mixture of 40 ml pyridine and 30 ml acetic anhydride and stirred for about 14-16 hours at room temperature. After that, the reaction mixture is poured onto about 300 ml crushed ice. A white solid matter is precipitated, filtered off, washed twice with water (50 ml each time) and dried on a rotation evaporator. In this way, the product is obtained in an almost quantitative yield.

(DC eluent: toluene/ethyl acetate=10/1, lactoside: R_{F}=0.24, maltoside: R_{F}=0.35)

| | Lactoside | Maltoside |
|---|---|---|
| Yield: | 98.6%, colourless | 95.3%, colourless |
| | crystals | crystals |

Sum formula (Mol mass): C₆₆H₆₄O₁₆ (1113.20 g/mol) NMR data for the lactoside: ¹³C-NMR (63 MHz, CDCl₃): δ=20.6, 20.6, 20.7, 20.7, 20.8 (5×C(O)CH₃), 60.5, 60.7 (C-6 glc, C-6 gal), 67.1, 68.9, 70.9, 71.6, 72.6, 73.3, 74.2, 74.9, (C-2-C-5 glc, C-2-C-5 gal), 99.3, 99.4 (C-1 glc, C-1 gal), 117.5, 123.2, 129.6, 157.0 (C-Phenyl), 143.2, 143.5 (2×C(Ph)₃), 168.7. 168.8, 169.8, 168.9, 170.1 (5×C(O)CH₃)

1-phenyl-2,3,3′,4′,5′-penta-O-acetyl-β-D-lactopyranoside from 1-phenyl-6,6′-di-O-trityl-2,3,3′,4′,5′-penta-O-acetyl-β-D-lactopyranoside with watery acetic acid

The de-tritylation is done according to a general provision )⁶. For this, 7.2 g (6.47 mmol) 1-phenyl-6,6′-di-O-trityl-2,3,3′,4′,5′-penta-O-acetyl-β-D-lactopyranoside is dissolved in 100 ml 80% watery acetic acid and stirred for 4-5 hours (DC control) at 90° C. bath temperature. After this, there is reduction on a rotation evaporator and chromatography. In this way, the product is obtained in moderate yields. )⁶ A. J. Fatiadi, Carbohydr. Res., 6 (1968), 237-238.

(lactoside: DC, SC eluent: toluene/ethyl acetate=1/1, R_{F}=0.18 maltoside: DC, SC eluent: toluene/ethyl acetate=1/1, R_{F}=0.26)

| | Lactoside | Maltoside |
|---|---|---|
| Yield: | 45.8%; amorphous | 78.1%; amorphous |

Sum formula (Mol mass): C₂₈H₃₆O₁₆ (628.58 g/mol) NMR data for the lactoside: ¹³C-NMR (63 MHz, CDCl₃): δ=20.5, 20.6, 20.7, 20.8, 20.9 (5×C(O)CH₃), 60.3, 62.0 (C-6 glc, C-6 gal), 66.8, 69.6, 71.4, 72.0, 72.8, 73.2, 74.8, 75.1 (C-2-C-5 glc, C-2-C-5 gal), 98.7, 100.9 (C-1 glc, C-1 gal), 116.6, 123.2, 129.6, 156.7 (C-Phenyl), 169.3, 169.6, 170.1, 170.3, 170.8 (5×C(O) CH₃). NMR data for the maltoside: ¹³C-NMR (63 MHz, DMSO-D₆): δ=20.5, 20.6, 20.7, 20.8, 20.9 (5×C(O)CH₃), 60.4, 61.0 (C-6 glc, C-6 gal), 70.0, 72.6, 73.0, 73.4, 73.7, 75.3, 76.4, 79.2 (C-2-C-5 glc, C-2-C-5 gal), 100.2, 100.9 (C-1 glc, C-1 gal), 116.3, 122.0, 129.6, 157.5 (C-Phenyl), 169.6, 170.1, 170.3, 170.5, 170.7 (5×C(O)CH₃).

1-phenyl-2,3,3′,4′,5′-penta-O-acetyl-6,6′-di-O-[Z-(ε)-amino-caproyl]-β-D-lacto-pyranoside from 1-phenyl-2,3,3′,4′,5′-penta-O-acetyl-β-D-lactopyranoside with Z-(ε)-aminocaproic acid

1.06 g (4 mmol) Z-(ε)-animocaproic acid is dissolved in 20 ml dry dichloromethane. 1.45 ml (20 mmol) thionyl chloride is added to the solution and the mixture stirred for 2 h with reflux at 60° C. After this, the solvent and surplus thionyl chloride are distilled off on a rotation evaporator. The rest is absorbed with 10 ml dry dichloromethane and converted with 1.12 ml (13.9 mmol) pyridine.

1.14 g (1.817 mmol) 1-phenyl-2,3,3′,4′,5′-penta-O-acetyl-β-D-lactopyranoside is dissolved in 20 ml dry dichloromethane. The solution obtained above is added. It is stirred for 48 hours at room temperature (DC control). For processing, the mixture is washed with 10% NaHCO₃ solution and then with distilled water. The organic phase is dried over Na₂SO₄ and reduced in a rotation evaporator. The raw product is cleaned with column chromatography.

(DC eluent: toluene/ethyl acetate=1/1, lactoside: R_{F}=0.45, maltoside: R_{F}=0.56 SC eluent: toluene/ethyl acetate=2/1)

| | Lactoside | Maltoside |
|---|---|---|
| Yield: | 38.6% | 27% |

Sum formula (Mol mass): C₅₈H₇₄N₂O₂₂ (1151.23 g/mol) NMR data for the lactoside: ¹³C-NMR (63 MHz, CDCl₃): δ=20.4, 20.5, 20.6, 20.8, 21.4 (5×C(O)CH₃), 24.2, 26.0, 29.5, 33.7, 40.7 (CH₂-Hexyl), 60.8, 61.8 (C-6 gal, C-6 glc), 66.4 (CH₂ (Cbz)), 66.5, 68.96, 69.0, 70.6, 70.9, 71.0, 71.4, 72.7 (C-2-C-5 glc, C-2-C-5 gal), 98.7, 101.1 (C-1 glc, C-1 gal), 116.8, 123.2, 128.0, 128.2, 128.4, 129.0, 129.5, 136.5, 156.7 (C-Phenyl, Cbz-Phenyl), 156.4 (2×Hexyl-N-C(O)-O), 169.0, 169.3, 169.6, 170.1, 170.2, 170.4 (5×C(O)CH₃), 172.8, 172.9 (C(O) (Cbz)). NMR data for the maltoside: ¹³C-NMR (63 MHz, CDCl₃): δ=20.5, 20.55, 20.6, 20.9, 21.4 (5×C(O)CH₃), 24.3, 26.0, 26.1, 29.5, 33.7, 33.75, 40.7 (CH₂-Hexyl), 61.3, 62.5 (C-6 gal, C-6 glc), 66.5 (CH₂ (Cbz)), 67.9, 68.5, 69.3, 69.9, 71.9, 72.2, 72.6, 75.2 (C-2-C-5 glc, C-2-C-5 gal), 95.6, 98.4 (C-1 glc, C-1 gal), 116.9, 123.3, 125.2, 128.0, 128.2, 128.4, 129.0, 129.5, 136.6, 156.7 (C-Phenyl, Cbz-Phenyl), 156.3 (233 Hexyl-N-C(O)-O), 169.4, 169.6, 169.9, 170.0, 170.1, 170.5 (5×C(O)CH₃), 172.9, 173.1 (C(O)(Cbz)).

1-phenyl-2,3,3′,4′,5′-penta-O-acetyl-6,6′-di-O-[(ε)-amino-caproyl]-β-D-maltopyranoside from phenyl-2,3,3′,4′,5′-penta-O-acetyl-6,6′-di-O-[Z-(ε)-amino-caproyl]-β-D-maltopyranoside with Pd/activated carbon

0.29 g (0.25 mmol) phenyl-2,3,3′,4′,5′-penta-O-acetyl-6,6′-di-O-[Z-(ε)-amino-caproyl]-β-D-maltopyranoside is dissolved in 25 ml methanol. 10 mg palladium/activated carbon (10%) is added to the solution. The resultant mixture is stirred under an H₂ atmosphere for 96 h at RT (DC control). For processing, the mixture is filtered and the filtrate reduced on a rotation evaporator. The cleaning of the raw products is done by column chromatography.

(DC eluent: toluene/ethyl acetate=1/1, R_{F}=0.27; SC eluent: toluene/ethyl acetate=2/1) Yield: 40.0% (colourless crystals) Sum formula (Mol mass): C₄₂H₆₂N₂O₁₈ (882.96 g/mol) NMR data: ¹³C-NMR (63 MHz, CDCl₃): δ=20.5, 20.6, 20.8, 20.9, 21.4 (5×C(O)CH₃), 29.7, 60.6 (CH₂-Hexyl), 61.2, 62.8 (C-6 gal, C-6 glc), 68.8, 69.3, 70.1, 71.0, 71.7, 72.0, 74.6, 75.4 (C-2-C-5 glc, C-2-C-5 gal), 95.5, 98.5 (C-1 glc, C-1 gal), 116.9, 123.2, 129.6, 156.7 (C-Phenyl), 169.6, 170.1, 170.5, 170.7, 171.2 (5×C(O)CH₃)

### EXAMPLE 11

Composite material of O-acetyl-polylactide 2000 and Dextran 6000

Solutions of EDC (95.6 mg in 1 ml water) and DMAP (61 mg in 1 ml acetonitrile) are added to a solution of Ac-PLA2000 (1 g) in acetonitrile (40 ml) in one portion. A solution of Dextran 6000 (3 g) in water is added to the mixture and the entire mixture agitated for 2 h at 50° C. This results in a white precipitation, which is centrifuged (3000 RPM, 10 min) and washed with 40 ml water. After this, it is centrifuged again and the solid matter dried in a vacuum.

¹H-NMR: δ=1.44, 1.46 (CH₃, PLA), 3.04-3.71 (m, CH, CH₂, Dextran), 4.66 (bd), 5.15-5.22 (m, CH, PLA); ¹³C-NMR: δ=16.7 (CH₃), 66.2 (CH₂), 68.9, 70.3, 70.6, 72.0, 72.7, 73.5, 98.4 (CH), 169.4 (C═O)

### EXAMPLE 12

Composite material of O-maleoyl-polylactide 2000 and the lectin UEA I

MS-PLA2000 (0.736 mg) and EDC (0.269 mg) are suspended in 0.1 M MES buffer solution and activated in an ultrasonic bath at room temperature for 30 minutes. The lectin UEA I (10 mg) is added and the mixture shaken at room temperature for 2 h. After this, the solid matter is centrifuged (3000 RPM, 10 min), washed twice with water and freeze-dried.

### Production of the Polylactide Components

O-maleoyl-polylactide 2000 of polylactide 2000 with maleic acid anhydride

10 g Polylactide 2000 is dissolved in 100 dichloromethane and 0.56 g maleic acid anhydride added by stirring at room temperature. After everything has dissolved, 0.7 g 2-fluoro-1-methyll-pyridine-tosylate is added as a catalyst and the reaction mixture is stirred overnight at room temperature. After this, the solution is reduced on a rotation evaporator to about 20 ml. The product is precipitated with 100 ml methanol. The suspension is centrifuged (5000 RPM 5 min) and the solid matter dried in a vacuum (in an exsiccator).

### EXAMPLE 13

Composite material of O-maleoyl-polylactide 2000 and albumin (BSA)

MS-PLA2000 (0.736 mg) and EDC (0.269 mg) are suspended in 0.1 M MES buffer solution and activated in an ultrasonic bath at room temperature for 30 minutes. BSA (20 mg) is added and the mixture shaken at room temperature for 2 h. After this, the solid matter is centrifuged (3000 RPM, 10 min), washed twice with water and freeze-dried.

### EXAMPLE 14

Composite material of O-(HO-Gly-Ala-Gly-Ala-Gly-Ala-carbonyl)polylactide-(diisopropylamide) 17000 and O-(8-Amino-3,6-dioxa-octylaminocarbonyl)polylactide(diisopropylamide) 17000

1. DCC (42 mg) is added to a solution of O-(HO-Gly-Ala-Gly-Ala-Gly-Ala-carbonyl)polylactide-(diisopropylamide) 17000 (1.73 g) in 40 ml tetrahydrofuran at 50° C. After 30 min, 1-Hydroxy-benzotriazol (27.2 mg) dissolved in 5 ml tetrahydrofuran is added to the solution. After this, the O-(8-Amino-3,6-dioxa-octylaminocarbonyl)polylactide(diisopropylamide) 17000 (1.73 g) dissolved in 40 ml tetrahydrofuran is added to the reaction mixture. It is left to react at 50° C. for 1 h. After reduction of the solution, it is washed three times with 25 ml methanol/water (v/v:50/50) and dried in a vacuum.

The determination of the degree of conversion is done by spectrophotometric determination of non-converted O-(8-Amino-3,6-dioxa-octylaminocarbonyl)polylactide(diisopropylamide) 17000. The yield of the target substance amounts to 80%. The mol mass of the final product is determined by means of GPC. Mw (R202H)=1,7047e⁴ g/mol Mw (Composite)=3,3125e⁴ g/mol

In an analogous way, the following peptide sequences can also be positioned between two polylactide strands:

2. H-Gln-Gly-OH

3. H-Leu-Tyr-Leu-Tyr-Trp_OH

4. H-Arg-Glu-His-Val-Val-Tyr-OH

5. H-Phe-Trp-Ala-OH

6. H-Gly-Gly-Gly-Gly-Gly-OH

7. H-Phe-Asp-OH

8. H-Leu-Tyr-Leu-Tyr-Trp-OH

### Production of the Polylactide Components

O-(norbornen-2,3-diicarboxamidoxycarbonyl)polylactide(diisopropylamide) 17000 of Polylactide (diisopropylamide) 17000 with N-(Chlorcarbonyloxy)-5-norbornen-2,3-dicarboximid (ClCOONB)

ClCOONB (182 mg) dissolved in dry dichloromethane (10 ml) is added to a solution of Polylactide(diisopropylamide) 17000 (8.55 g) in dry dichloromethane (40 ml) by stirring. After this, pyridine (60 μl) is added. The solution is stirred for 18 h. After reduction on a rotation evaporator, the crystalline mass is mortared finely and washed with water. The solid matter obtained is lyophilised.

Activation is determined via a test for N-Hydroxy-5-norbornen-2,3-dicarboximide (HONB) and is quantitative. The yield is between 95 and 98%.

O-(8-Amino-3,6-dioxa-octylaminocarbonyl)polylactide(diisopropylamide) 17000 of O-(Norbornen-2,3-diicarboxamidoxycarbonyl)polylactide(diisopropylamide) 17000 with 1,8-Diamino-3,6-dioxaoctane

1.73 g O-(Norbornen-2,3-diicarboxamidoxycarbonyl)polylactide(diisopropylamide) 17000 is dissolved in dry acetone (30 ml). The acetonic solution is set to pH 9 with triethylamine. 1,8-Diamino-3,6-dioxaoctane (30 mg) is added to 10 ml acetone and added to the polylactide solution by stirring. Stirring is done for two hours at room temperature.

After this, the solution is neutralised with 0.1 M acetic acid. The solution is reduced by rotation. The crystalline mass is washed with water and subsequently lyophilised.

The degree of conversion is seen via determination of the free amino-group of 1,8-Diamino-3,6-dioxaoctane. The degree of conversion corresponds to the polylactide component used. The yield amounts to 82%.

O-(HO-Gly-Ala-Gly-Ala-Gly-Ala-carbonyl)polylactide-(diisopropylamide) 17000 of O-(Norbornen-2,3-diicarboxamidoxycarbonyl)polylactide(diisopropylamide) 17000 and hexapeptide (H-Ala-Gly-Ala-Gly-Ala-Gly-OH)

O- (Norbornen-2,3-diicarboxamidoxycarbonyl)polylactide(diisopropylamide) 17000 (3.46 g) is dissolved in acetonitrile (30 ml). The solution is heated to 50° C. and set to a pH value of 9 with triethylamine. The hexapeptide is dissolved in an equimolar way in acetonitrile (10 ml) as triton B salt. The polylactide solution is added to the hexapeptide solution. It is stirred for 3 h at 50° C. After reduction of the solution on a rotation evaporator, the crystalline mass is washed neutral with 0.1 M acetic acid, subsequently rinsed with water. The solid matter obtained is lyophilised.

The degree of conversion is determined analogously to an amino acid analysis via the acid disintegration. It amounts to 95%. The yield is 85%.

### EXAMPLE 15

Composite material of O-(HO-Ala-Gly-maleoyl)polylactide(diisopropylamide) 17000 und O-(8-Amino-3,6-dioxa-octylamidomaleoyl)polylactide(diisopro-pylamide) 17000

1. DMAP (about 60 mg) is added to a solution of O-(HO-Ala-Gly-maleoyl)polylactide(diisopropylamide) 17000 (0.2 mmol), O-(8-Amino-3,6-dioxaoctylamidomaleoyl)polylactide(diisopropyl-amide) 17000 (0.2 mmol) and 1-hydroxybenzotriazol (54 mg) in tetrahydrofuran (40 ml) until a pH value of 9 is reached and then a solution of EDC (77 mg) in tetrahydrofuran (2 ml) is added. The reaction mixture is stirred for 1 h at 50° C. and 64 h at room temperature and then set to pH 6 with 0.1 M hydrochloric acid. All the volatile components are removed from the reaction mixture at 40° C. in a vacuum and the residue mixed with water (30 ml). The product precipitation is filtered off, washed three times with 25 ml methanol/water (v/v:50/50) and dried in a vacuum.

Yield of composite material: 78% (quantitative proof of the amino-groups after acid disintegration)

The following oligopeptides are converted in an analogous way according to this method:

2. H-Gly-Ala-Ala-OH

3. H-Ala-Gly-OH

4. H-Gly-Ala-Gly-Ala-Gly-Ala-OH

4. H-Ala-Gly-Ala-Gly-Ala-Gly-OH

### Production of the Polylactide Components

O-(maleoyl)polylactide (diisopropylamide) 17000 of polylactide(diisopropylamide) 17000 with maleic acid anhydride

Maleic acid anhydride (60 mg) and FMPT (170 mg) are added to a solution of polylactide(diisopropylamide) 17000 (5 g) in dichloromethane (25 ml). The reaction mixture is stirred for 16 h at 50° C. and then reduced to about 10 ml in a vacuum at 40° C. The remaining oil is washed three times with 25 ml methanol/water (v/v:50/50) for 2 min each time in an ultrasonic bath and the viscous product dried in a vacuum.

O-(8-amino-3,6-dioxa-octylamidomaleoyl)polylactide(diisopropylamide) 17000 of O-(maleoyl)polylactide(diisopropylamide) 17000 with 1,8-diamino-3,6-dioxaoctane

Triethylamine (12 mg) and a solution of DCC (25 mg) in chloroform (5 ml) are added to a solution of O-(maleoyl)polylactide(diisopropylamide) 17000 (1 g) in chloroform (20 ml). The reaction mixture is stirred for 1 h at 50° C. and then 1,8-diamino-3,6-dioxaoctane (18 mg) is added. Then, it is stirred at room temperature for 64 h and the reaction mixture set to pH 6 with 0.1 M hydrochloric acid. All the volatile components are removed from the reaction mixture at 40° C. in a vacuum and the residue washed three times with methanol (5 ml each time) in an ultrasonic bath for 2 min each time. The viscous product is dried in a vacuum.

Yield: 84% (quantitative proof of the amino-group after acid disintegration)

O-(HO-Ala-Gly-maleoyl)polylactide(diisopropylamide) 17000 of O-(maleoyl)-polylactide(diisopropylamide) 17000 with dipeptide (H-Gly-Ala-OH)

DMAP is added to a solution of O-(maleoyl)polylactide(diisopropylamide) 17000 (3.4 g) in tetrahydrofuran (20 ml) (about 60 mg) until a pH figure of 9 is reached and then a solution of EDC (38 mg) in tetrahydrofuran (1 ml) is added. The reaction mixture is stirred for 1 h at 50° C. and then the triton B salt of H-Gly-Ala-OH in 2 ml tetrahydrofuran/water (v/v:80/20) is added equimolar. Then, it is stirred at room temperature for 64 h and the reaction mixture set to pH 6 with 0.1 M hydrochloric acid. All the volatile components are removed from the reaction mixture at 40° C. in a vacuum and the residue mixed with water (30 ml). The product precipitation is filtered off, washed three times with water (30 ml each time) and dried in a vacuum.

Yield: 75% (quantitative proof of the amino-group after acid disintegration)

### EXAMPLE 16

Composite material of Bis(acetylmercaptosuccinyl)Ala-Ala-Lys(OH) and (Iodacetyl) or (Chloracetyl)polylactide(diisopropylamide) 17000

1. According to a modified provision by Klotz )^{e} and Rector )^{f} 32.4 mg (0.1 mmol) H-Ala-Ala-Lys-OH.HCl are dissolved in 24 ml dioxan/water (2:1). With 1M NaOH a pH figure of 7 is achieved. 69.7 mg (0.4 mmol) S-acetyl mercaptosuccine anhydride is added to this solution in portions within 5 min. The pH figure is kept around 7 by automatic titration with 1M NaOH. After complete addition of the anhydride, it is stirred for 30 min at RT with pH control. The completeness of the conversion is confirmed by reaction with Ninhydrin. The clear solution is washed with diethyl ether. The AMSA-Ala-Ala-Lys(OH)-AMSA is obtained by lyophilising the watery phase. )⁷ Klotz, I. M. and Heiney, R. G., J. Am. Chem. Soc. 81, 3802-3803 (1959). )⁸ Rector, E. S.; Schwenk, R. J.; Tse, K. S. and Sehon, A. H., J. Immunol. Methods 24, 321-336 (1978).

The lyophilisate is dissolved in 24 ml acetone/water (2:1) under N₂ atmosphere. By addition of a base (1M NaOH or 50% H₂N—OH) the S-acetyl groups are fissured. The resultant product is not isolated. A solution of 0.2 mmol X-Ac-PLA17-IPA (X=I, Cl) in 100 ml acetone is added to this solution drop by drop. The reaction mixture is stirred for 4 h at RT. Then, the solvent is removed in a vacuum. The solid matter obtained is thoroughly washed with water, filtered off and lyophilised.

Yield: 88.2% Amino-acid analysis: 65% recovery

The following oligopeptides are converted according to this method:

2. H-Ala-Gly-Lys-OH

3. H-Gly-Gly-Lys-OH

4. H-Gly-Ala-Asp-Ser-Pro-Lys-OH

### Production of the Polylactide Components

(Iodacetyl)polylactide(diisopropylamide) 17000 (I-Ac-PLA17-IPA) of Polylactide-(diisopropylamide) 17000 with iodine acetic acid anhydride

4.275 g (0.25 mmol) polylactide(diisopropylamide) 17000 is dissolved in 35 ml dry acetone. A solution of 180 mg (0.5 mmol) iodine acetic acid anhydride in 15 ml dry acetone is added to this solution. After addition of 76.5 μl (0.55 mmol) triethylamine, the reaction mixture is stirred for 5 h at 80° C. with reflux. After cooling, the solvent is removed in a vacuum. The solid matter obtained is thoroughly washed with distilled water, filtered and lyophilised.

Yield: 4.2 g (97.8%) Elementary analysis iodine: ber.: 0.7%, gef.: 0,65%.

### EXAMPLE 17

Composite material of ATA-(Ac)Lys-Phe-Lys-Gly-Gly-Arg-Ala-Lys(Amide)-ATA•TFA and (iodine acetyl) or (chloracetyl) polylactide (diisopropylamide) 17000

12.8 mg (0.01 mmol) ATA-(Ac)Lys-Phe-Lys-Gly-Gly-Arg-Ala-Lys(Amide)-ATA•TFA (M: 1278.4 g/mol) is dissolved in 12 ml acetone/water (2:1) under N₂ atmosphere. Addition of a base (1M NaOH or 50% H₂N—OH) fissures the S-acetyl groups. The resultant product is not isolated. A solution of 0.02 mmol X-Ac-PLA17-IPA (X=I, Cl) in 20 ml acetone is added to this solution drop by drop. The reaction mixture is stirred for 4 h at RT. After this, the solvent is removed in a vacuum. The solid matter obtained is thoroughly washed with water, filtered off and lyophilised.

Yield: 87.2% Amino-acid analysis: 67% recovery

### EXAMPLE 18

Micro-encapsulation of a Rabbit IgG Preparation with a Composite Material According to Example 14

1 g of a lyophilised Rabbit IgG preparation (grain size 1 to 5 μm) is suspended in 100 ml petrol ether (80-110° C.) (100 ml) by stirring. For this, a solution of 1 g of composite material from Example 14 and 5 ml acetone are added in 10 portions within 5 h. Stirring is done for a further hour. After sedimentation, the suspension is filtered, washed with 20 ml petrol ether and air-dried.

### EXAMPLE 19

Micro-encapsulation of BSA reactive red 2 with a composite material according to example 15

A According to a modified variant of Birnbaum et al.)⁹, a 0.4% polyvinyl alcohol solution (54 ml) is saturated with acetic ester by stirring (magnetic agitator) at 500 RPM. 1 g of composite according to example 15 is dissolved in 5 ml acetic ester. In it, BSA-RR2 as a spray-drying product is dispersed (100 mg). )⁹ Birnbaum, D. T.; Kosmala, J. D.; Henthorn, D. B.; Brannon-Peppas, L., J. Contr. Release 65, 375-387 (2000)

After completion of the dispersion process, the composite solution is quickly added to the polyvinyl alcohol solution and stirred for 2 min at a speed of at least 500 RPM. This emulsion is poured into 200 ml water and stirred at 500 RPM for at least 4 h.

It is sedimentated and filtered via 200 μm gauze. If the particles <10 82 m, they are centrifuged at 3000 RPM for 2 min, the supernatant solution poured off, re-suspended with water, centreifuged for a second time and then lyophilised. Larger particles are only sedimentated, slurried once more with aqua dest. after removal of the supernatant solution and sedimentated once more. After removal of the supernatant solution, the particles are lyophilised.

### Production of BSA Reactive Red 2

BSA is dissolved in MES-C buffer at room temperature. The reactive red 2 is added to the solution and stirred overnight at room temperature.

The protein precipitation is done with ammonium sulphate. For this, (NH₄)₂SO₄ is added in portions during the course of 1 hour. The solution is cooled with ice water during this. Then, the suspension is centrifuged (10000 RPM, 5 min). The solid matter is deep-frozen (−30° C.) and freeze-dried.

### EXAMPLE 20

Micro-encapsulation of Albumin (BSA) with a Composite Material According to Example 9

1 g of composite material according to Example 9 is dissolved in 10 ml methylene chloride. For this, a solution of 20 mg BSA is added to 500 μ water with dispersion. The emulsion is dripped into 300 ml of a 1% polyvinyl alcohol solution at 500 RPM. Further stirring is done for 30 minutes, centrifuging for 5 min at 1800 RPM. The supernatant solution is separated. The particles are re-suspended with a little water, centrifuged again and dried in a vacuum.

### EXAMPLE 21

Micro-encapsulation of BSA Reactive Red 2 with a Composite Material According to Example 14

A solution of BSA-RR2 in 500 μl water is added by the drop to a solution of composite material according to example 14 (2.4 g) in 10 ml acetone or acetonitrile. 1.2 g Span 80 is weighed into a beaker glass and mixed with mineral oil (60 ml). The emulsifier is evenly distributed in the oil in an ultrasonic bath.

The composite solution is put into motion with a propeller agitator and peanut oil slowly added. The stirring speed is raised to 700 RPM. It is stirred for 2 min and then 250 ml petrol ether quickly poured in. It is stirred overnight until the particles harden out. The particles are washed with petrol ether, filtered via a Buchner funnel and air-dried.

### EXAMPLE 22

Micro-encapsulation of Albumin (BSA) with a Composite Material According to Example 16 by Means of Spray-drying

200 mg BSA are dissolved in 200 ml water. In it, a solution of 10 g of composite material according to Example 16 are dispersed in 100 ml methylene chloride in such a way that the methylene chloride practically completely evaporates and a stable emulsion results. This emulsion is then spray-dried.

Equipment conditions)¹⁰: Inlet temperature 93° C., outlet temperature 63-66° C., aspirator: 98%, pump: 10% )¹⁰ Mini Spray Dryer of the company Büchi Labortechnik GmbH

### EXAMPLE 23

Micro-encapsulation of Albumin (BSA) with a Composite Material According to Example 17 by Means of Spray-drying

10 g of the composite material according to Example 17 is dissolved in dichloromethane (200 ml). 400 mg BSA is dissolved in water (12 ml) and dispersed in the composite solution for about 60 sec. at 13500 to 20000 RPM.

After spray-drying, the particles are lyophilised. Equipment conditions )¹⁰: Inlet temperature 46° C., outlet temperature 33° C., aspirator: 100%, pump: 25% )¹⁰ Mini Spray Dryer of the company Büchi Labortechnik GmbH

### EXAMPLE 24

Core-shell Encapsulation of Rabbit IgG/PLA 17000 Cores with Composite Materials According to Example 10

1 g Rabbit IgG/PLA 17000 cores (produced analogous to Example 12, d=1-10 μm) are re-suspended in 50 ml petrol ether (80-110° C.) by stirring. A solution of 0.05 g composite material according to Example 10 and 0.05 g PLA 17000 in 2 ml acetone are dripped in. Stirring is done for a further hour. After sedimentation, the suspension is filtered, washed with 20 ml petrol ether and air-dried.

The re-suspended particles agglutinate quantitatively with anti-Ulex coated, fluorescent silicate particles (d=800 nm).

### EXAMPLE 25

Micro-encapsulation of Silicate Particles (Impregnated with Amaranth) with a Composite Material According to Example 9

Synthetic silicate particles (d=800 nm) are used as a core material. 2 g of silicate particles are shaken in a watery Amaranth solution (50 mg/50 ml water) for 10 min, centrifuged and dried. 1 g of these particles is suspended in 100 ml petrol ether (80-110° C.). For this, a solution of 1 g composite material according to Example 7 and 5 ml acetone are dripped in as 10 portions within 5 h. Stirring is done for a further hour. After sedimentation, the suspension is filtered, washed with 20 ml petrol ether and air-dried.

The release examinations are done in the incubation shaker at 37° C. in PBS buffer at pH 7.3. 200 mg of particles are suspended in 10 ml PBS buffer. To examine the enzyme influence on the stability of the particle cover, β-galactosidase (20 units) is added before the particles are added. 500 μl of solution are taken at an interval of 30 min and analysed spectral-photometrically for the content of Amaranth at a wavelength of 520 nm.

The results are summarised in FIG. 3.

### EXAMPLE 26

Release Examinations with Micro-particles Produced According to Examples 19 to 23

Before the examination of the release properties of the particles produced, the overall content of encapsulated protein is determined. For this, 50 mg of particles is dissolved in 2 ml DMSO. After this, 10 ml 0.1 N NaOH (0.5% SDS) is added to the DMSO solution and the solution shaken for 1 h at 37° C. After this, the samples are measured with spectrophotometry. The calibration line is produced with the same solvent mixture. The release examination is done both with and also without addition of substrate-specific enzymes. The following substrate-specific enzymes are added for micro-particles of composite materials from Examples 14 to 17:

Pancreatic elastase (14.1., 15.1. to 15.5., 16.1. to 16.4., 17.), rhino-virus protease 3C (14.2.), Chlamydia pneumoniea endopeptidase CLP1 (14.3.), granulocyte elastase (14.4.), Chymotrypsin (14.5., ), Staphylococcus Protease Lysostaphin (14.6.), Candida albicans Protease Sap2 (14.7.), Campylobacter jejuni (14.8.).

The current activity of the enzymes is determined before use. On the basis of USP 23, the Paddle method was used in a modified way. 100 ml PBS buffer (0.01% NaN₃) is tempered at 37° C. 200 mg of particles is rinsed into the release vessel with 50 ml buffer solution and stirred at about 100 RPM. After 10, 20, 30, 40, 50 and 60 min, 2 ml of solution are removed each time in such a way that no loss of particles occurs. This volume is compensated by the addition of 2 ml buffer solution.

In a second series of tests, the calculated amount of enzymes is added to the buffer solution. Sample volumes free of particles are removed at the same intervals of time as above. Degrees of calibration in the release buffer solutions are produced for the content determinations.

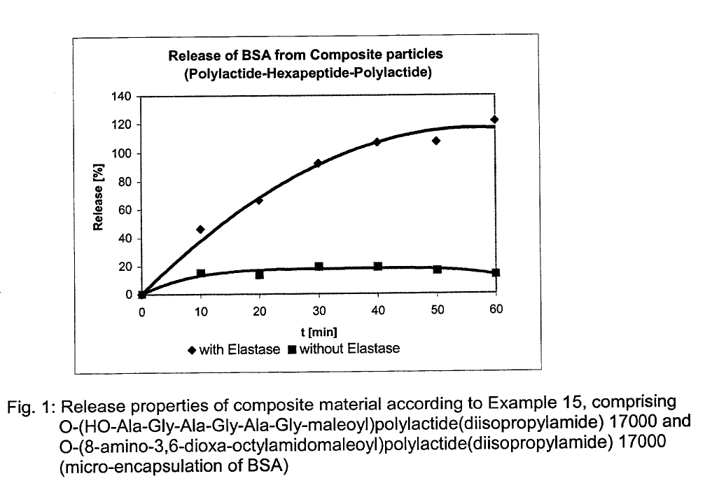

The release properties of the composite materials are explained with an example (FIG. 1)

1. Biodegradable polymeric composite materials of tri-block construction, in which the polymeric composition is covalent connected, for the production of micro-capsules of solid or dissolved materials or preparations in organic solvents or watery emulsions, wherein they have a polymeric composition of the general formula
R¹ₙ—P^{1—}(Q—P²)ᵢ—R²ₘ,
with P¹ and P² representing the same or different macromolecular structures,
R¹ and R² representing the same or different end groups or protective groups or receptor molecules or markers,
i, n and m being natural numbers and individually being zero or one with the proviso that if i=1, (m+n) is greater than or equal to 1, and if i=0, m and n=1 and
Q representing an at least bi-functional structure with hydrophilic properties, derived from the area of polyols,
polyamides and polyester,
with the composition for splitting the bonds between the sub-structures R, P and/or inside Q having a enzymatic recognition site and/or interface.

2. Composite material according to claim 1, wherein P¹ and P² are polymers with structure elements from the areas of polyester, polyamide/amine or polysaccharide or of hydroxycarbonic acids, their salts or esters.

3. Composite material according to claim 2, wherein polyesters are polyglycolides, polylactides, Poly(hydroxy butter acids) or co-polymers resulting therefrom.

4. Composite material according to claim 2, wherein polysaccharides are polygalacturonic acid or algin acid.

5. Composite material according to claim 1, wherein the end or protective groups R¹ and/or R² are acyl, alkyl or alkoxycarbonyl groups.

6. Composite material according to claim 1, wherein R¹ and/or R² represent marker, receptor or molecules otherwise specifically binding on structures, preferably from the material classes of the oligopeptides, proteins, glycoproteins and oligonucleotides.

7. Composite material according to claim 1, wherein the structure element Q represents a compound derived from mono, oligo or polysaccharides which, if need be, have amino or carboxy groups, or a compound which is derived from di, oligo or polypeptides

8. Composite material according to claim 1, wherein the structure element Q is a molecule which can be fissured by enzymes.

9. Composite material according to claim 8, wherein the structure element Q has a di or polysaccharide.

10. Composite material according to claim 8, wherein the structure element Q has an oligopeptide with a defined protease interface.

11. Composite material according to claim 1, wherein compounds of the general formula are used in which i=zero or i=1.

12. Use of polymeric composite material according to claim 1 for the temporary separation of materials from the surrounding milieu.

13. Use according to claim 12 in a number of covers with differing enzyme recognition sites and interfaces.

14. Use according to claims 12 with differing marker or receptor molecules R¹ and/or R².

15. Use according to claim 14 with differing marker or receptor molecules R¹ and/or R², which recognise extra and/or intra-cellular structures.

16. Use of composite materials according to claim 12 for the purposeful transport and release of substances with an immunological and/or pharmacological/toxic effect.

17. Method for the production of micro-capsules of solid or dissolved substances or preparations, wherein composite materials according to claim 1 are dissolved in organic solvents or watery emulsions thereof are produced and the encapsulation is done by methods known per se.
